(19) United States
(12) Patent Application Publication
(10) Pub. No.: US 2026/0269964 A1
(43) Pub. Date: Sep. 10, 2026

(54) METHOD, DEVICE AND COMPUTER READABLE MEDIUM FOR COMMUNICATIONS

(71) Applicant: NEC Corporation, Tokyo (JP)

(72) Inventors: Xincai LI, Beijing (CN); Gang WANG, Beijing (CN)

(73) Assignee: NEC Corporation, Tokyo (JP)

(21) Appl. No.: 18/873,535

(22) PCT Filed: Jun. 17, 2022
(86) PCT No.: PCT/CN2022/099600

§ 371 Date: Dec. 10, 2024

(51) Int. Cl. H04B 17/309; H04B 7/06; H04B 17/318; H04L 5/00; H04W 56/00; H04W 72/21

(52) U.S. Cl. CPC H04B 17/346; H04B 7/06968; H04B 17/328; H04L 5/0051; H04W 56/0015; H04W 72/21

(57) ABSTRACT

Embodiments of the present disclosure relate to methods, devices and computer readable media for Cross Link Interference (CLI) management using a beam sweep procedure. According to embodiments of the present disclosure, a first network device receives a CLI measurement configuration from a second network device. The CLI measurement configuration indicates at least one of: a set of communication resources for a downlink transmission of the second network device or a set of CLI Reference Signals (RS) to be transmitted by the second network device using a transmit beam sweep. The first network device further performs, using a receive beam sweep, a measurement on the at least one of the set of communication resources or the set of CLI RSs.

### FIELD

Embodiments of the present disclosure generally relate to the field of communications, and in particular, to a method, device and computer readable medium for Cross Link Interference (CLI) management using a beam sweep procedure.

### BACKGROUND

With development of the communication technology, the density of deployment for network devices and cells becomes quite high. Further, network device have been further designed to operate in a full-duplex mode to improve the communication efficiency. In this case, the interference between communication devices may be occurred frequently with increasing of the density of radio signals in a certain space. For example, in the full-duplex communication mode, the network devices may transmit downlink (DL) data transmission and receive Uplink (UL) data transmission simultaneously. Accordingly, there may be a CLI situation that a network device receives UL transmission while another adjacent network device performs DL transmission which may affect the UL reception. In one solution, the network devices eliminate the CLI between terminal devices by negotiating a synchronization mechanism of the UL and DL data transmission with each other. However, in the duplex communication mode, the CLI cannot be eliminated only based on this mechanism. Further, the CLI management between terminal devices is also a key aspect.

### SUMMARY

In general, example embodiments of the present disclosure relate to methods, devices and computer readable media for CLI management using a beam sweep procedure.

In a first aspect, there is provided a communication method. In the method, a first network device receives a CLI measurement configuration from a second network device. The CLI measurement configuration indicates at least one of: a set of communication resources for a downlink transmission of the second network device or a set of CLI Reference Signals (RS) to be transmitted by the second network device using a transmit beam sweep. The first network device performs, using a receive beam sweep, a measurement on the at least one of the set of communication resources or the set of CLI RSs.

In a second aspect, there is provided a communication method. In the method, a second network device transmits a CLI measurement configuration to a first network device. The CLI measurement configuration indicates at least one of a set of communication resources for a downlink transmission of the second network device or a set of CLI RS. The second network device transmits, in a transmit beam sweep, the at least one of the set of communication resources or the set of CLI RSS

In a third aspect, there is provided a communication method. In the method, a first terminal device receives a CLI measurement configuration from a first network device. The CLI measurement configuration indicates at least one of a set of communication resources for a uplink transmission of a second terminal device or a set of CLI RS to be transmitted by a second terminal device using a transmit beam sweep. The first terminal device performs, using a receive beam sweep, a measurement on the at least one of the set of communication resources or the set of CLI RSs.

In a fourth aspect, there is provided a communication method. In the method, a second terminal device receives a CLI measurement configuration from a second network device. The CLI measurement configuration indicates at least one of a set of communication resources for an uplink transmission of a second terminal device or a set of CLI RS. The second terminal device transmits, using a transmit beam sweep, the at least one of the set of communication resources or the set of CLI RSs.

In a fifth aspect, there is provided a communication method. In the method, a first network device transmits a CLI measurement configuration to a first terminal device, the CLI measurement configuration indicating at least one of a set of communication resources for a uplink transmission of a second terminal device or a set of CLI RS to be transmitted by a second terminal device using a transmit beam sweep. The first network device receives a CLI measurement report from the first terminal device.

In a fourth aspect, there is provided a network device. The network device comprises a processor and a memory coupled to the processor and storing instructions thereon, the instructions, when executed by the processor, causing the network device to perform the method of any one of the first aspect to the first aspect, the second aspect and the fifth aspect.

In a fifth aspect, there is provided a terminal device. The terminal device comprises a processor and a memory coupled to the processor and storing instructions thereon, the instructions, when executed by the processor, causing the terminal device to perform the method of the third aspect and the fourth aspect.

In a sixth aspect, there is provided a computer readable medium having instructions stored thereon, the instructions, when executed on at least one processor, causing the at least one processor to perform the method of any one of the first aspect to the fifth aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which some embodiments of the present disclosure can be implemented;

FIG. 2 illustrates a signaling process of the CLI management using a beam sweep procedure according to some embodiments of the present disclosure;

FIG. 3 illustrates a flowchart of an example method according to some embodiments of the present disclosure;

FIG. 4 illustrates an example environment in which some embodiments of the present disclosure can be implemented;

FIG. 5 illustrates a signaling process of the CLI management using a beam sweep procedure according to some embodiments of the present disclosure;

FIG. 6A illustrates a resource adjustment for transmission of CLI measurement report according to some embodiments of the present disclosure;

FIGS. 6B and 6C illustrate flowcharts according to some embodiments of the present disclosure;

FIG. 7 illustrates a flowchart of an example method implemented at a first network device according to some embodiments of the present disclosure;

FIG. 8 illustrates a flowchart of an example method implemented at a second network device according to some embodiments of the present disclosure;

FIG. 9 illustrates a flowchart of an example method implemented at a first terminal device according to some embodiments of the present disclosure;

FIG. 10 illustrates a flowchart of an example method implemented at a second terminal device according to some embodiments of the present disclosure;

FIG. 11 illustrates a flowchart of an example method implemented at another first network device according to some embodiments of the present disclosure; and

FIG. 12 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may be also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information. The terminal or the network device may work on several frequency ranges, e.g. FR1 (410 MHz-7125 MHz), FR2 (24.25 GHz to 71 GHz), 71 GHz to 114 GHz, and frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As mentioned above, the CLI may be occurred frequently with the density of radio signals in a certain space increasing, especially in the case that the network device operates in the full-duplex mode. One solution for the CLI management between network devices is that the network devices negotiate the UL-DL transmission configuration with each other. However, the negotiation of the UL-DL transmission is a static CLI management, which is not able to handle randomly occurred CLI issue. Further, existing solutions mainly adopt Layer 3 reporting which is based on periodic CLI measurement resources with Layer 3 filtering. These solutions focus on long-term statistic of interference. This is not suitable for enabling fast adjustment in response to interference variation. Further, the beam optimization procedure of a communication device are only used for select a pair of beams between network device and terminal device for data communication, however it has not been used for CLI management.

The example embodiments of the disclosure propose a mechanism for the CLI management using a beam sweep procedure. In this mechanism, a first network device receives a Cross Link Interference (CLI) measurement configuration from a second network device. The CLI measurement configuration indicates at least one of: a set of communication resources for a downlink transmission of the second network device or a set of CLI Reference Signals (RS) to be transmitted by a second network device using a transmit beam sweep. The first network device further performs, using a receive beam sweep, a measurement on the at least one of the set of communication resources or the set of CLI RSs.

In this way, using the beam sweeping procedure, a network device may determine a CLI level associated with a spatial beam of the network device, the network device may eliminate the CLI from other network devices by adjusting the beams to be used by these devices accordingly. As such, the CLI elimination or management can be achieved by Layer 1 reporting which is more flexibility than Layer 3 reporting.

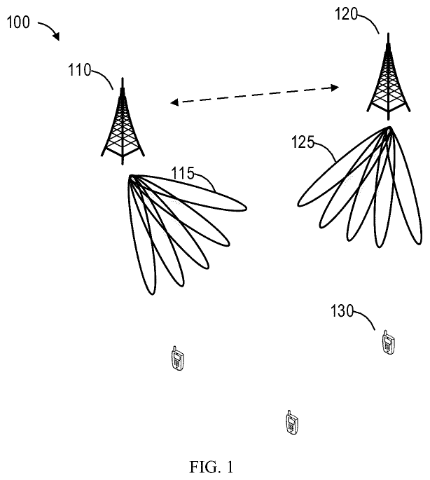

FIG. 1 illustrates an example environment 100 in which example embodiments of the present disclosure can be implemented.

The environment 100, which may be a part of a communication network, comprises a first network device 110, a second network device 120, a number of terminal devices comprising a terminal device 130. In some embodiments, the first network device 110 and second network device 120 may operate in full-duplex mode. For example, in some situations, the network device 110 may receive an uplink data transmission from the terminal device 130 and transmit a downlink data transmission to another terminal device simultaneously. The first network device 110 and the second network device 120 are capable of performing data transmission in different spatial directions based on multi-beams capability. For discussion clarity, a set of receive beams 115 of the first network device 110 and a set of transmit beams 125 of the second network device 120 are shown. For example, the first network device 110 may perform UL reception via a beam of the set of receive beam 115, and the second network device 120 may perform DL transmission via a beam of the set of transmit beam 125. Further, in some situations, if a receive beam of the first network device 110 and a transmit beam of the second network device 120 overlap with each other in spatial, then the UL reception of the first network device 110 may be interfered when the second network device 120 performs DL transmission.

It is to be understood that the number of terminal devices and network device is shown in the environment 100 only for the purpose of illustration, without suggesting any limitation to the scope of the present disclosure. In some embodiments, the environment 100 may comprise a further terminal device to communicate information with a further network device.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

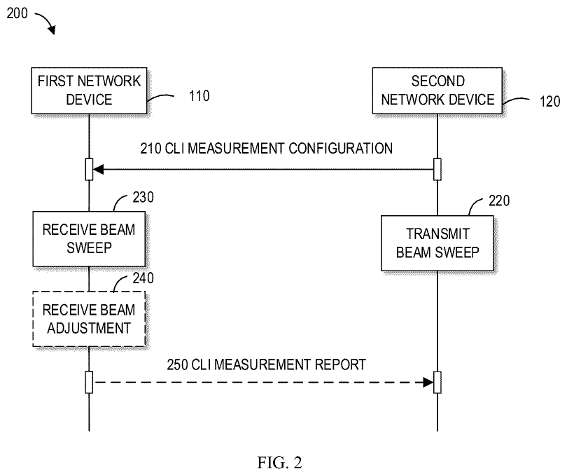

FIG. 2 illustrates a signaling process 200 of the CLI management using a beam sweep procedure according to some embodiments of the present disclosure. For purpose of discussion, the process 200 will be described with reference to FIG. 1.

In the signaling process 200, at step 210, the first network device 110 receives a CLI measurement configuration from the second network device 120.

In some embodiments, the first network device 110 may receive CLI measurement configuration from the second network device 120 through Xn or F1 air interface directly. In addition or alternatively, the first device 110 may receive CLI measurement configuration from the second network device 120 via Access and Mobility Management Function (AMF) or Operation Administration and Maintenance (OAM). In this case, the AMF or OAM may obtain the CLI measurement configuration from the potential aggressor network device, for example the second network device 120. Then, the AMF or OAM may configure the CLI measurement configuration to the victim network device, for example the first network device 110.

The CLI measurement configuration indicates at least one of: a set of communication resources for a downlink transmission of the second network device 120 or a set of CLI Reference Signals (RS) to be transmitted by the second network device 120 using a transmit beam sweep.

In some embodiments, the CLI measurement configuration indicates the set of communication resources for a downlink transmission of the second network device 120. The second network device 120 may perform downlink data transmission to served terminal devices on the set of communication resources. Accordingly, the UL reception on the set of communication resources of the first network device 110 may be interfered by the second network device 120. The indicated communication resource may comprise spatial resources, time resources and frequency resources.

In some embodiments, the CLI measurement configuration may indicate a set of Transmission Configuration Indication (TCI) states. A TCI state in the set of Transmission Configuration Indication (TCI) states corresponds to a transmit beam of the second network device 120 for the each frequency sub-band, each of the plurality of TCI states may be indicated by a Synchronization Signal Block (SSB) resource Index or Non Zero Power-Channel State Information (NZP-CSI)-RS-ResourceId. For example, a TCI state is assumed to be Quasi-Colocation (QCL) with a SSB resource Index, or NZP-CSI-RS-ResourceId in a sub-band or a Resource Block (RB) set. In addition or alternatively, the CLI measurement configuration may further indicate at least one of a set of Orthogonal Frequency Division Multiplexing (OFDM) symbols and a set of Physical Resource Blocks (PRB) of each frequency sub-band of the second network device.

As such, based on the indicated set of communication resources, the first network device 110 may be aware of the potential CLI affected communication resources, and the CLI measurement may be performed accordingly.

In addition or alternatively, the CLI measurement configuration may indicate a set of CLI RSs, and a CLI RS may comprise at least one of the following signals which are used for transmit beam sweep of the second device 120: a SSB and CSI RS specific to a serving cell associated with the second network device 120. As discussed above, based on the QCL assumption, when performing the receive beam sweep, each of the SSB resource ID and CSI RS resource ID is associated with a respective beam, and the respective beam can be determined by the first network device 110 accordingly when receiving a CLI RS.

Based on the CLI measurement configuration, the victim network device, for example the first network device 110, may determine to detect which RS and measure which communication resources for the CLI management.

At step 220, the second network device 120 transmits the at least one of the set of communication resources or the set of CLI RSs in a transmit beam sweep. For example, the second network device 120 transmits the at least one of the set of communication resources or the set of CLI RSs by sweeping through each beam of the transmit beams 125. In some embodiments, the SSB and CSI RS are used for the beam sweeping procedure. For example, the transmit device 120 may transmit corresponding SSB and CSI RS in a certain transmit beam during the transmit beam sweep. As such, the SSB and CSI RS may be adopted as the CLI RS for the CLI management or may be the transmitted signal in the indicated set of the communication resources. In some embodiments, the second network device 120 may further transmit the at least one of the set of communication resources or the set of CLI RSs across a plurality of discontinuous sub-bands.

In turn, at step 230, using a receive beam sweep, the first network device 110 performs the measurement on the at least one of the set of communication resources or the set of CLI RSs.

In some embodiments, if the CLI measurement configuration indicates a set of the communication resources, the first network device 110 measures at least one of Received Signal Strength Indicator (RSSI) and the Signal to Interference plus Noise Ratio (SINR) of each in the set of communication resources.

In addition or alternatively, if the CLI measurement configuration indicates a set of CLI RSs, the first network device 110 measures at least one of Reference Signal Receiving Power (RSRP) and the SINR of each in the set of CLI RSs. In addition, in some embodiments, the first network device 110 may further perform the measurement across a plurality of discontinuous sub-bands.

The result of the above measurement indicates the quality of the signals received from the second network device 120. In a sense, the higher RSRP of a received CLI RS or the higher RSSI detected on communication resource, the greater the influence from a corresponding transmit beam of the second network device 120. Based on the above measurement, the first network device 110 may determine one or more transmit beams of the second network device 120 which interfere UL reception significantly and further eliminate the interference by reporting to the second network device 120 or adjusting the receive beam for UL.

In some embodiments, the first network device 110 may order the measurement values from the largest to smallest or from the smallest to the largest, each of measurement value corresponds to a transmit beam of the second network device 120 based on CLI RS. As discussed above, the transmit beam may be indicated by CLI RS resource ID, for example ID of SSB resource or CSI RS resource for the transmit beam sweep. In this way, the first network device 110 may determine the corresponding transmit beam based on the association between ordered measurement value and measured CLI RS (ID) or measured communication resource, wherein the communication resource may carry the SSB, CSI RS or other DL signal/channel. As such, the first network device 110 may determine the number of (for example, L) transmit beams which correspond to the same number of CLI RSs having the largest or smallest measurement values.

In addition or alternatively, there may be one or more predefined measurement thresholds, the first network device 110 may find the number of transmit beams which correspond to the same number of CLI RSs having the largest or smallest measurement values by comparing the measurement values and the measurement threshold. In addition or alternatively, the first network device 110 may determine the number of transmit beams which correspond to the same number of CLI RSs having the largest or smallest measurement values in any other approach.

In turn, the first network device 110 may report transmit beams which correspond to CLI RSs having the largest or smallest measurement to the second network device 120 for avoiding the CLI. In some embodiments, the first network device 110 transmits a CLI measurement report which is generated based on the measurement to the second network device 120. In some embodiments, the CLI measurement report may comprise a first number of CLI RS resource IDs associated with the transmit beam of the second network device 120. Each CLI RS resource ID corresponds to a CLI RS resource having a measurement value of the first number of measurement values of the measurement performed on the set of CLI RS. In some embodiments, each of the first number measurement values is greater than a first threshold. In this case, CLI RS ID may comprise SSB resource ID and CSI RS resource ID corresponding to the transmit beam of the second network device 120. At the second network device 120, based on the CLI RS resource ID in the CLI measurement report, the transmit beams which affect significantly UL reception of the first network device 110 can be determined. Accordingly, in order to eliminating the CLI, the second network device 120 may use transmit beams other than the beam identified by these CLI RS resource ID for DL transmission. In some embodiments, the CLI measurement report may only comprise the CLI RS resource ID corresponding to the largest measurement value. In addition, the CLI measurement report may further comprise the measure values corresponding to the first number of CLI RS resource IDs. In an example, the measurement values may be indicated based on one absolute value and a plurality of relative values. For example, the largest value and a plurality of offset values relative to the largest value.

In addition or alternatively, in some embodiments, the CLI measurement report may comprise a second number of CLI RS resource IDs associated with the transmit beam of the second network device 120. Each CLI RS resource ID corresponds to a CLI RS resource having a measurement value of the second number of measurement values of the measurement performed on the set of CLI RS. In some embodiments, each of the first number measurement values is smaller than a second threshold. At the second network device 120, based on the CLI RS resource ID in the CLI measurement report, the transmit beams which not affect or affect slightly UL reception of the first network device 110 can be determined. Accordingly, in order to eliminating the CLI, the second network device 120 may use transmit beams identified by these CLI RS resource IDs for DL transmission. In some embodiments, the CLI measurement report may only comprise the CLI RS resource ID corresponding to the smallest measurement value. In addition, the CLI measurement report may further comprise the measurement values corresponding to the second number of CLI RS resource IDs.

In addition or alternatively, the CLI RS ID may be reported per sub-band. In some embodiments, the CLI measurement report may comprise CLI RS resource ID specified to a frequency sub-band, wherein CLI RS resource ID corresponds to a CLI RS having the largest measurement value in the frequency sub-band. For example, CLI RS resource ID corresponding to each sub-band is reported. Such as the CSI RS Indicator (CRI) or SSB-resource ID with the highest Layer 1-RSRP, Layer 1-SINR or Layer 1-RSSI for subband 1, the CRI or SSB-resource ID with the highest Layer 1-RSRP, L1-SINR or Layer 1-RSSI for subband 2, the CRI or SSB-resource ID with the highest Layer 1-RSRP, Layer 1-SINR or Layer 1-RSSI for sub-band n, n is the number of the sub-band number for DL.

Regarding the transmission of the CLI measurement report, it may be transmitted periodically. For example, the transmission periodic and the offset or the slot index is configured by OAM/AMF or exchanged between two network devices. For instance, the periodicity is one value of among the periodicity set {5 ms, 10 ms, 20 ms, 40 ms, 80 ms, 160 ms, 320 ms, 640 ms}.

The timing configuration may indicate a periodic and a time offset or some slot index. In some other embodiments, the CLI measurement report may be transmitted on predefined slots, such as slot 2n, 4n, 5n, 9n and so on, n is a positive integer.

In addition or alternatively, the transmission of the CLI measurement report may be turned on or turned off. For example, if the maximum measurement value is greater than a threshold, the first network device 110 transmits the CLI measurement report. In addition or alternatively, if the measured/reported signal quality is lower than a threshold, then the CLI measurement is not required to be transmitted by the first network device 110 in a further time duration.

In addition to eliminating CLI at the second network device 120 or alternatively, the CLI may be also eliminated at victim network device, for example the first network device 120.

In some embodiments, the first network device 110 may determine the receive beams which are affected by the second network device 120 significantly and avoid to use these determined receive beams for UL reception. In some embodiments, a threshold may be predefined for determining the affected receive beam, if the measurement value associated with a receive beam is above the threshold, this receive beam may be determined as the affected receive beam.

In this disclosure, the above operations for the CLI management may be also expressed as below.

A new information for inter-gNB beam CLI management can be defined
in 38.413/38.423/38.473 for duplex. This Information Transfer function
allows the transfer of CLI-beam measurement and report information
between two RAN nodes via the core network. The purpose of the
Downlink CLI-duplex Information Transfer procedure is to transfer
CLI-beam measurement and report information from the AMF to the
NG-RAN node. The AMF does not interpret the transferred CLI-beam
measurement and report information. This procedure uses non-UE
associated signalling. The NG-RAN node may use the CLI-beam
measurement and report information for executing the gNB-gNB CLI
beam management functionality.
Or gNB1 can directly signal CLI-beam measurement and report for each
subband to gNB2 through Xn/F1. This inter-gNB beam CLI management
IE conveys the at least one of the below IE.

| | | | | |
|---|---|---|---|---|
| | | | IE type | |
| IE/Group | | | and | Semantics |
| Name | Presence | Range | reference | description |

| | | | |
|---|---|---|---|
| CLI-RS | M | 9.3.1.x | The RS/resource |
| configuration | | | configuration |
| | | | for gNB-gNB |
| | | | RS-RSRP |
| | | | measurement, |
| | | | including |
| | | | SSB-RI, CRI. |
| CLI-RSSI | M | 9.3.1.x | The resource |
| measurement | | | for gNB-gNB |
| resource | | | CLI-RSSI |
| configurations | | | measurement, |
| | | | including |
| | | | the symbols |
| | | | and the RBs, |
| | | | the list of |
| | | | TCI statesin |
| | | | each subband. |
| The L1- | M | 9.3.1.x | The list of |
| RSRP/RSSI/ | | | report slot |
| SINR Report | | | index or a |
| configuration | | | periodic |
| information | | | and offset. |

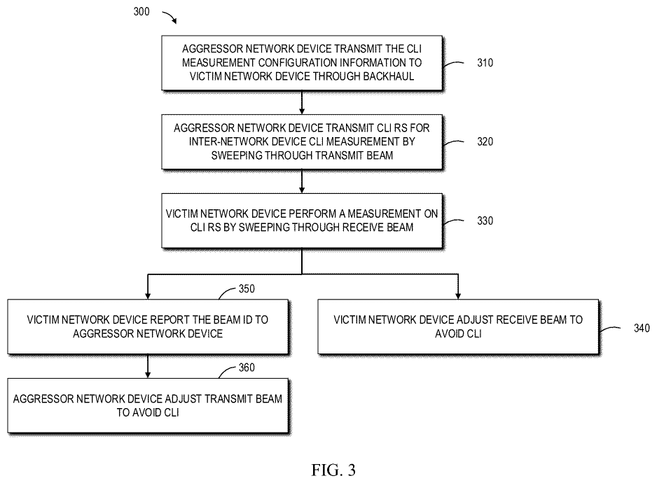

FIG. 3 illustrates a flowchart 300 of an example method according to some embodiments of the present disclosure.

In the flow chart 300, at 310, the aggressor network device, for example, the second network device 120, transmits the CLI measurement configuration to victim network device, for example the first network device 110, through a backhaul.

At 320, the aggressor network device transmit CLI RS for inter-network device CLI measurement by sweeping through the aggressor transmit beams.

At 330, the victim network device performs a measurement on CLI RS by sweeping through receive beams.

At block 340, the victim network device adjust receive beam to avoid CLI based on the measurement.

In addition or alternatively, at block 350, the victim network device reports the beam ID to the aggressor network device.

At block 360, the aggressor network device adjust transmit beam to avoid CLI based on the report.

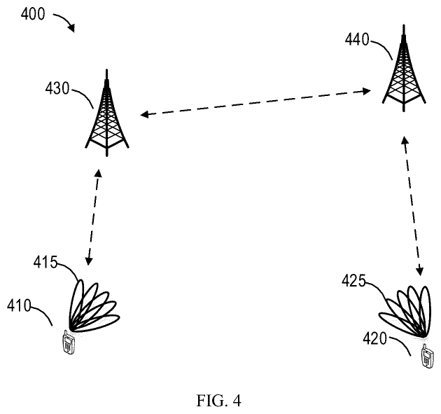

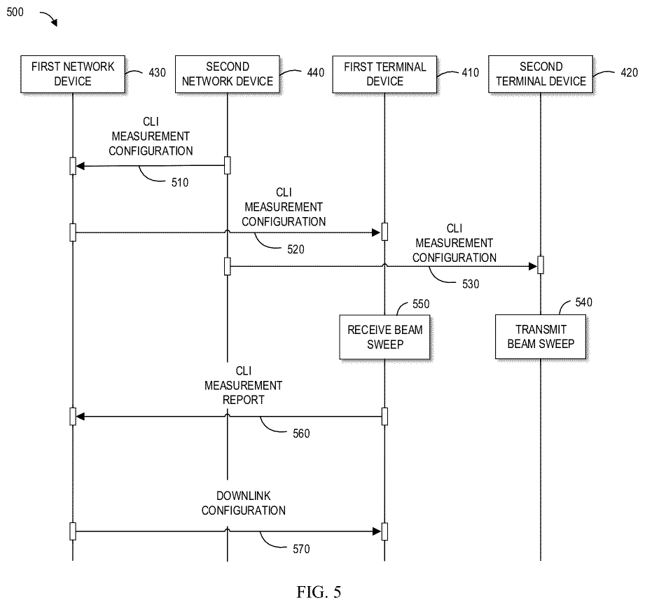

In addition to CLI management between network devices, the CLI between terminal devices may be also addressed by using beam sweep procedure. The CLI management between terminal devices is discussed with reference to FIGS. 4-5.

FIG. 4 illustrates an example environment 400 in which some embodiments of the present disclosure can be implemented.

The environment 400, which may be a part of a communication network, comprises a first terminal device 410, a second terminal device 420, a first network device 430 serving the first terminal device 410 and a second network device 440 serving the second terminal device 420. In some embodiments, the first network device 430 and second network device 440 may operate in full-duplex mode. For example, in some situations, the first network device 410 may receive an uplink data transmission from a terminal device and transmit a downlink data transmission to another terminal device simultaneously. The first terminal device 410 and the second terminal device 420 are capable of performing data transmission in different spatial directions based on multi-beams capability. For discussion clarity, a set of receive beams 415 of the first terminal device 410 and a set of transmit beams 425 of the second network device 420 are shown. For example, the first terminal device 410 may perform DL reception via a beam of the set of receive beam 415, and the second terminal device 420 may perform UL transmission via a beam of the set of transmit beam 425. Further, in some situations, if a receive beam of the first terminal device 410 and a transmit beam of the second network device 420 overlap with each other in spatial, then the DL reception of the first terminal device 410 may be interfered when the second terminal device 420 performs UL transmission.

It is to be understood that the number of terminal devices and network device is shown in the environment 400 only for the purpose of illustration, without suggesting any limitation to the scope of the present disclosure. In some embodiments, the environment 400 may comprise a further terminal device to communicate information with a further network device.

The communications in the environment 400 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

FIG. 5 illustrates a signaling process 500 of the CLI management using a beam sweep procedure according to some embodiments of the present disclosure. For purpose of discussion, the process 500 will be described with reference to FIG. 4.

In the signaling process 500, at step 510, the first network device 430 receives a CLI measurement configuration from the second network device 440. In the same way as signaling process 200, the first network device 430 may receive the CLI measurement configuration from the second network device 440 through Xn or F1 air interface directly or via AMF or OAM. The CLI measurement configuration indicates at least one of a set of communication resources for a uplink transmission of a second terminal device 420 or a set of CLI Reference Signals (RS) to be transmitted by the second terminal device 420 using a transmit beam sweep.

Similarly, in some embodiments, the CLI measurement configuration may indicate a set of OFDM symbols, a set of PRBs of each frequency sub-band and a set of TCI states. In the CLI management between terminal devices, a TCI state in the set of TCI states corresponds to a receive beam of the first terminal device 410 for the each frequency sub-band, each of the plurality of TCI states may be indicated by a CLI RS resource ID. For example, a TCI state is assumed to be Quasi-Colocation (QCL) with a SRS resource ID, a SSB resource Index, or NZP-CSI-RS-ResourceId in a sub-band or a RB set. In addition or alternatively, the CLI measurement configuration may further indicate at least one of a set of Orthogonal Frequency Division Multiplexing (OFDM) symbols and a set of Physical Resource Blocks (PRB) of each frequency sub-band of the second network device.

As such, based on the indicated set of communication resources, the first terminal device 410 may be aware of the potential CLI affected communication resources, and the CLI measurement may be performed accordingly.

In addition or alternatively, the CLI measurement configuration may indicate another set of CLI RSs, and a CLI RS in the other CLI RS set may comprise Sounding Reference Signal (SRS) for the CLI management between terminal devices.

At step 520, the first network device 430 transmits the CLI measurement configuration to the served first terminal device 410. At step 530, the second network device 440 transmits the CLI measurement configuration to the served second terminal device 420.

Based on the CLI measurement configuration, the victim network device, for example the first terminal device 410, may determine to detect which RS and measure which communication resources for the CLI management. Correspondingly, the aggressor terminal device, for example the second terminal device 420, may determine to transmit which RS and perform data transmission on which communication resources for the CLI management.

Accordingly, at step 540, the second terminal device 420 transmits, using a transmit beam sweep, the at least one of the set of communication resources or the set of CLI RSs indicated in the CLI measurement configuration. For example, the second terminal device 420 transmits the at least one of the set of communication resources or the set of CLI RSs by sweeping through each beam of the transmit beams 425. For example, the transmit device 120 may transmit corresponding SRS in a certain transmit beam during the transmit beam sweep. As such, the SRS may be adopted as the CLI RS for the CLI management or may be the transmitted signal in the indicated set of the communication resources. In some embodiments, the second terminal device 420 may further transmit the at least one of the set of communication resources or the set of CLI RSs across a plurality of discontinuous sub-bands.

In turn, at step 550, using a receive beam sweep, the first terminal device 410 performs the measurement on the at least one of the set of communication resources or the set of CLI RSs.

In some embodiments, if the CLI measurement configuration indicates a set of the communication resources, the first terminal device 410 measures at least one of Received Signal Strength Indicator (RSSI) and the Signal to Interference plus Noise Ratio (SINR) of each in the set of communication resources.

In addition or alternatively, if the CLI measurement configuration indicates a set of CLI RSs, the first terminal device 410 measures at least one of Reference Signal Receiving Power (RSRP) and the SINR of each in the set of CLI RSs. In addition, in some embodiments, the first terminal device 410 may further perform the measurement across a plurality of discontinuous sub-bands.

The result of the above measurement indicates the quality of the signals received from the second terminal device 420. In a sense, the higher RSRP of a received CLI RS or the higher RSSI detected on communication resource, the more interference experienced on the corresponding receive beam of the first terminal device 410. Based on the above measurement, the first terminal device 410 may determine one or more receive beams which are affected significantly and further eliminate the interference by reporting to the first network device 430 for adjusting the receive beam for DL.

In some embodiments, the first terminal device 410 may order the measurement values on the receive beams from the largest to smallest or from the smallest to the largest, each of measurement value corresponds to a receive beam of the first terminal device 410. As discussed above, the receive beam may be indicated by TCI state ID comprised in the CLI measurement configuration from the first network device 430. In this way, the first terminal device 410 may determine the affected receive beams and report the corresponding TCI state ID to the first network device 430, for example, in a CLI measurement report.

In turn, at step 560, the first terminal device 410 may report the determined receive beams having the largest or smallest measurement to the first network device 430 for avoiding the CLI. In some embodiments, the first terminal device 410 may determine a third number of (for example, K) receive beams which correspond to the K largest measurement values. In turn, the first terminal device 410 may report the respective K TCI state IDs of the K receive beams to the first network device 430 in the CLI measurement report. In some embodiments, the receive beam may be also indicated by SRI in the CLI measurement report. In addition, the CLI measurement report may also comprise CLI RS resource ID associated with the K largest measurement values, such as SRS-ResourceConfigID or CLI-RSSI Measurement Resource ID. In addition, the CLI measurement report may further comprise the measurement values corresponding to the third number of CLI RS resource IDs.

In some embodiments, the first terminal device 410 may determine a fourth number of (for example, K) receive beams which correspond to the N smallest measurement values. In turn, the first terminal device 410 may report the respective N TCI state IDs of the N receive beams to the first network device 430 in the CLI measurement report. In addition, the CLI measurement report may also comprise CLI RS resource ID associated with the K largest measurement values, such as SRS-ResourceConfigID or CLI-RSSI Resource ID. In addition, the CLI measurement report may further comprise the measurement values corresponding to the fourth number of CLI RS resource IDs. The measurement value may comprise any of Layer 1 SRS-RSRP, L1 SINR and L1 CLI RSSI. In an example, the measurement values may be indicated based on one absolute value and a plurality of relative values. For example, the largest value and a plurality of offset values relative to the largest value.

In addition or alternatively, the CLI measurement report may comprise at least one TCI state ID associated with a receive beam of the first terminal device 410, and the at least one TCI state ID indicates the preferred receive beam for DL reception.

In some embodiments, the CLI measurement report may comprise a timing configuration for transmitting the CLI measurement report. For example, the CLI measurement report may comprise the periodic of the transmission. Further, the CLI measurement report may comprise reportConfigType {periodic, sps, aperiodic}.

In turn, at step 570, the first network device 430 may indicate a DL configuration to the first terminal device 410 based on the CLI measurement configuration. The CLI measurement configuration may comprise TCI state ID indicating the receive beam to be used by the first terminal device 410.

In some embodiments, if the CLI measurement report comprises a set of TCI state IDs, each corresponds to one of a plurality of the receive beams on which the measurement values are above a threshold. In this case, the downlink configuration may indicate a TCI state ID (which is also referred to as a first TCI state ID) other than the set TCI state IDs in the CLI measurement report.

In addition or alternatively, if the CLI measurement report comprises another set of TCI state IDs, each corresponds to one of a plurality of the receive beams on which the measurement values are below another threshold. In this case, the downlink configuration may indicates the first terminal device to use the receive beam corresponding to a TCI state ID (which is also referred to as a second TCI state ID) in the other set TCI state IDs in the CLI measurement report.

In addition or alternatively, if the CLI measurement report only comprises at least one TCI state ID which identify at least one preferred receive beam, the first network device 430 may directly consider a preferred receive beam of the at least one preferred receive beam as the beam to be used by the terminal device 410 for DL reception. Further, the first network device 430 will not transmit the downlink configuration, and the first terminal device 410 may use the at least one preferred receive beam automatically. In addition or alternatively, the first network device 110 may also transmit the downlink configuration comprise the one TCI state ID of the at least one TCI state ID as an acknowledgement.

In some embodiments, the DL configuration may be transmitted or indicated by MAC CE or DCI. In some embodiments, the CLI measurement report is carried by PUCCH or piggybacked on PUSCH, and the information include at least one of: the TCI state ID with the Layer 1-RSRP or Layer 1-SINR (this is the preferred beam for DL data receive) lower than a threshold, K TCI state IDs. Further, a variation report can also be considered. For example, if 4 beams are reported, then 4 TCI states and 1 Layer 1-RSRP, Layer 1-RSSI, Layer 1-SINR with 3 differential Layer 1-RSRPs, Layer 1-RSSI, Layer 1-SINR can be reported. Furthermore, group based report method can also be considered if multiple beam report is needed and UE has the ability to receive multiple beams. The report can be per sub-band based named as sub-band CLI measurement report, and this report mode can be configured, if this is not configured, then wideband CLI measurement report is assumed.

In some embodiments, the CLI measurement report is transmitted periodically, and wherein the CLI measurement report is transmitted in Physical Uplink Control Channel (PUCCH), the PUCCH being transmitted on a transmit beam which is same as the transmit beam for at least one of a latest Physical Uplink Shared Channel (PUSCH) and a latest Physical Radom Access Channel (PRACH).

In an example, for aperiodic CLI report carried on PUSCH, the DCI can indicate the PUSCH transmission beam, such as the SRI information can be used for PUSCH when only aperiodic CLI report is triggered. For example, DCI format 0_1 is used for trigger the aperiodic CLI beam reporting, such as the CLI reporting can be directly settled as the CSI report. In addition or alternatively, a new bit field, such as CLI request is added in DCI format 0_1. The number of CLI request bits is based on higher layer configured parameter cli-reportTriggerSize. The higher layer configured parameter aperiodicCLI-TriggerStateList can be configured to terminal device for aperiodic CLI report trigger. In this case, the DCI may trigger one state of the semi-persistent or aperiodic.

In some embodiments, the CLI measurement report is transmitted in a communication resource which is configured by the first network device, the communication resource being configured based on a communication resource for SSB transmission. For example, if the first terminal device 410 is configured by higher layers to transmit PUCCH, or PUSCH in a set of symbols of a slot, and the terminal device 410 detects a DCI format 2_0 with a slot format value that indicates a slot format with a subset of symbols from the set of symbols as downlink or flexible (that used for transmit data for other terminal devices), or if the inter-subslot frequency hopping for PUCCH repetitions transmission or other kind of PUCCH repetition transmission overlapped with the SSB slot, then the first terminal device 410 can transmit the PUCCH on the other sub-band that not overlapped with the SSB. The new sub-band index or a frequency/RB set offset for PUCCH can be configured by RRC or dynamically indicated by the first network device 430.

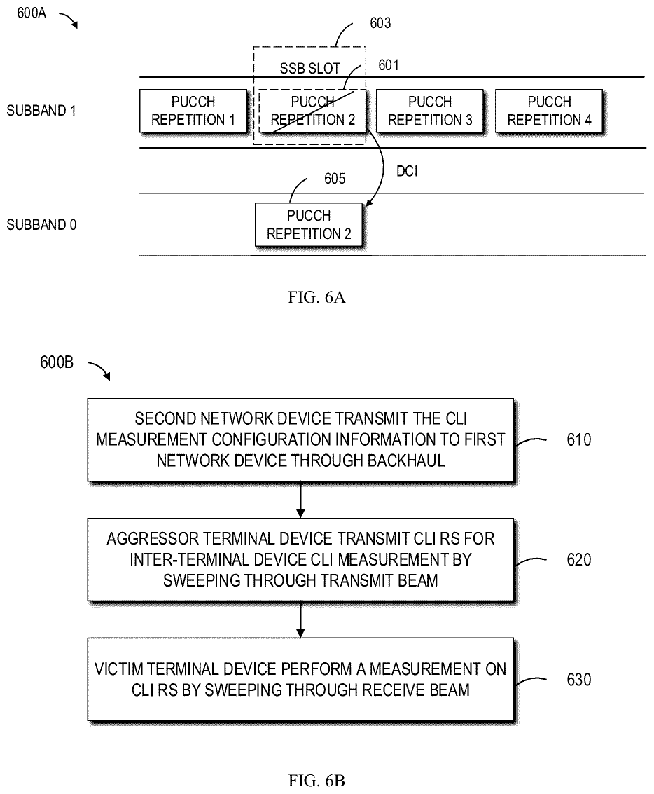

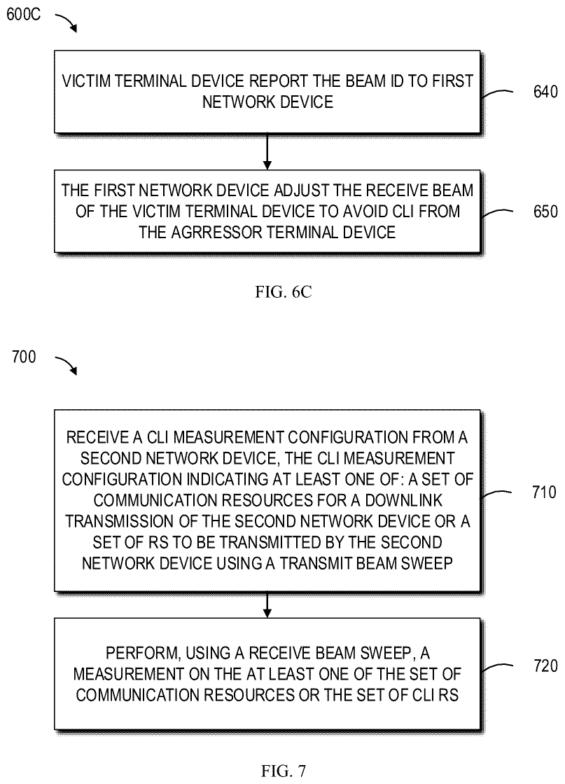

FIG. 6A illustrates a schematic FIG. 600A resource adjustment for transmission of CLI measurement report according to some embodiments of the present disclosure.

In the schematic FIG. 600A, the PUCCH or PUSCH repetitions for the CLI measurement report are transmitted on sub-band 1. Meanwhile, a SSB slot 603 overlaps the PUCCH repetition 2 603. In this case, the first network device 430 may indicate the first terminal device 410 to adjust the transmission of PUCCH 603 from the sub-band 1 to sub-band 0 which is also configured for UL transmission.

In this disclosure, the above operations for the CLI management between terminal devices may be also expressed as below.

```
  CLI-measurement Config information element can be defined and added in 38.331
for UE-to-UE CLI measurement and the IE can include at least one of the below
information:
  CLI-measurementConfig ::=
  CLI-measurement Type CHOICE {
    SRS-RSRP SEQUENCE {
    SRS-ResourceToAddModList,
    TCI-StateIdToAddModList},
    CLI-RSSI-Resource-config SEQUENCE {
    List of Starting OS and ending OS or number of OSs, List of Starting PRB and
ending PRB or number of PRBs,
    TCI-StateIdToAddModList, }}
  subcarrierSpacingforCLI-Measurement SubcarrierSpacing,
  aperiodicTriggerStateList SetupRelease { CLI-AperiodicTriggerStateList }
OPTIONAL, -- Need M
  semiPersistentOnPUSCH-TriggerStateList SetupRelease { CLI-
SemiPersistentOnPUSCH-TriggerStateList }
```

| Fields | Descriptions |
|---|---|
| CLI-measurement Type | Can be chose from{L1-SRS-RSRP, L1- |
| | CLI-RSSI, L1-CLI-SINR } |
| SRS-ResourceToAddModList | A list of SRS resource for UE-to-UE CLI |
| | SRS-RSRP beam measurement |
| TCI-StateIdToAddModList | A list of TCI states for receive SRS/UL |
| | for each subband |
| CLI-RSSI-Resource-config | A list of UL resource for UE UE-to-UE |
| | CLI-RSSI beam measurement |
| subcarrierSpacingforCLI- | Reference subcarrier spacing for |
| Measurement | CLI-RSSI measurement |

```
  CLI-ReportConfig information element can be designed and added in 38.331 and the
IE can include at least one of the below information:
  resourcesForChannelMeasurement SRS-ResourceConfigId or CLI-RSSI Id,
  reportConfigType CHOICE {
    periodic SEQUENCE {
    reportSlotConfig CSI-ReportPeriodicityAndOffset,
    pucch-CSI-ResourceList SEQUENCE (SIZE (1..maxNrofBWPs)) OF PUCCH-
CSI-Resource},
    semiPersistentOnPUCCH SEQUENCE {
    reportSlotConfig CSI-ReportPeriodicityAndOffset,
    pucch-CSI-ResourceList SEQUENCE (SIZE (1..maxNrofBWPs)) OF PUCCH-
CSI-Resource },
    semiPersistentOnPUSCH SEQUENCE {
    reportSlotConfig ENUMERATED {sl5, sl10, sl20, sl40, sl80, sl160, sl320},
    reportSlotOffsetList SEQUENCE (SIZE (1.. maxNrofUL-Allocations)) OF
INTEGER(0..32),
    p0alpha P0-PUSCH-AlphaSetId },
    aperiodic SEQUENCE { reportSlotOffsetList SEQUENCE (SIZE (1..maxNrofUL-
Allocations)) OF INTEGER(0..32)
  reportQuantity, CHOICE { SRI-RSRP, CLI-RI-RSSI, RI-SINR}
  groupBasedBeamReporting CHOICE { enabled, disabled SEQUENCE
{ nrofReportedRS}}
  PUCCH-CSI-Resource ::= SEQUENCE { Subband or RB Set-Id, pucch-Resource
PUCCH-ResourceId }
  reportFreqConfiguration SEQUENCE CLI-FormatIndicator ENUMERATED
{ widebandCLI, subbandCLI } -- Need R cli-ReportingBand CHOICE { subbands3 BIT
STRING(SIZE(3)), subbands4 BIT STRING(SIZE(4)), subbands5 BIT
STRING(SIZE(5)), subbands6}
```

| | |
|---|---|
| aperiodicCLI- | Contains trigger states for dynamically selecting |
| TriggerStateList | one or more aperiodic and semi-persistent CLI |
| | reporting configurations and/or triggering one or |
| | more aperiodic CLI-RS resource sets for cross-link |
| | interference measurement. The beam information |
| | (e.g. QCL type D) to UE for receiving the SRS/UL |
| | for doing aperiodic RSRP/CLI-RSSI measurement |
| | is also included. |

FIG. 6B illustrates a flowchart 600B according to some embodiments of the present disclosure.

At 610, the second network device 440 transmits the CLI measurement configuration information to the first network device 430 through backhaul.

At 620, the aggressor terminal device, for example the second terminal device 420, transmits CLI RS for inter terminal device CLI measurement by sweeping through transmit beams.

At 630 the victim terminal device, for example the first terminal device 410, perform a measurement on CLI RS by sweeping through the receive beams.

FIG. 6C illustrates a flowchart 600C according to some embodiments of the present disclosure.

At 640, the victim terminal device reports the beam ID to the first network device 430.

At 650, the first network device 430 adjust receive beam of the victim terminal device to avoid CLI from the aggressor terminal device.

FIG. 7 illustrates a flowchart of an example method 700 implemented at a network device according to some embodiments of the present disclosure. The method 700 can be implemented at the first network device 110 shown in FIG. 1. For the purpose of discussion, the method 700 will be described with reference to FIG. 1. It is to be understood that the method 700 may include additional acts not shown and/or may omit some shown acts, and the scope of the present disclosure is not limited in this regard.

At 710, the first network device 110 receives a CLI measurement configuration from a second network device 120. The CLI measurement configuration indicates at least one of: a set of communication resources for a downlink transmission of the second network device or a set of CLI RS to be transmitted by the second network device 120 using a transmit beam sweep.

At 720, using a receive beam sweep, the first network device 110 performs a measurement on the at least one of the set of communication resources or the set of CLI RSs.

In some embodiments, the first device 110 receives the CLI measurement configuration comprises at least one of: receiving the CLI measurement configuration via AMF or OAM.

In some embodiments, a CLI RS of the set of CLI RS comprises at least one of: Channel State Information (CSI) RS specific to a serving cell associated with the second network device, and Synchronization Signal Block (SSB).

In some embodiments, the first device 110 performs the measurement comprising: measuring at least one of Reference Signal Receiving Power (RSRP) and Signal to Interference plus Noise Ratio (SINR) of each RS in the set of CLI RS.

In some embodiments, the CLI measurement configuration indicating the set of communication resources is indicative at least one of: a set of Orthogonal Frequency Division Multiplexing (OFDM) symbols; a set of Physical Resource Blocks (PRB) of each frequency sub-band; and a set of Transmission Configuration Indication (TCI) states, each corresponding to a transmit beam of the second network device for the each frequency sub-band, each TCI state being indicated by a CLI RS resource ID.

In some embodiments, the first device 110 performs the measurement comprising: performing the measurement across a plurality of discontinuous sub-bands of the second network device.

In some embodiments, the method 700 further comprises: transmitting, to the second device 120, a CLI measurement report which is generated based on the measurement and wherein the CLI measurement report comprises: a first number of CLI RS resource IDs, a CLI RS resource ID in the first number of CLI RS resource ID corresponds a CLI RS resource having one of the first number of measurement values of the measurement performed on the set of CLI RS, each of the first number measurement values is greater than a first threshold, the measurement value comprising at least one of RSRP, RSSI and SINR, the first number being an integer larger than or equal to one.

In some embodiments, the CLI measurement report further comprises: the first number of measurement values each corresponding to a CLI RS resource ID in the first number of CLI RS resource ID.

In some embodiments, the method 700 further comprises: transmitting, to the second device 120, a CLI measurement report which is generated based on the measurement and wherein the CLI measurement report comprises: a second number of CLI RS resource ID, a CLI RS resource ID in the second number of CLI RS resource ID corresponds a CLI RS resource having one of the second number of measurement values of the measurement performed on the set of CLI RS, each of the second number of measurement values is smaller than a second threshold, the second number being an integer larger than or equal to one.

In some embodiments, the CLI measurement report further comprises: the second number of measurement values each corresponding to a CLI RS resource ID in the second number of CLI RS resource ID.

In some embodiments, the method 700 further comprises the first network device 110 transmits, to the second device 120, a CLI measurement report which is generated based on the measurement and wherein the CLI measurement report comprises: CLI RS resource ID specified to a frequency sub-band, wherein CLI RS resource ID corresponds to a CLI RS having the largest measurement value in the frequency sub-band.

In some embodiments, transmitting the CLI measurement report comprises at least one of: transmitting the CLI measurement report periodically; transmitting the CLI measurement report based on a timing configuration received from at least one of OAM and AMF, the timing configuration indicating at least one of periodic, slot index and time offset; and transmitting the CLI measurement report on a predefined slot.

In some embodiments, transmitting the CLI measurement report comprises: in response to a measurement value indicating signal quality being greater than a threshold, the first device 110 transmits the CLI measurement report.

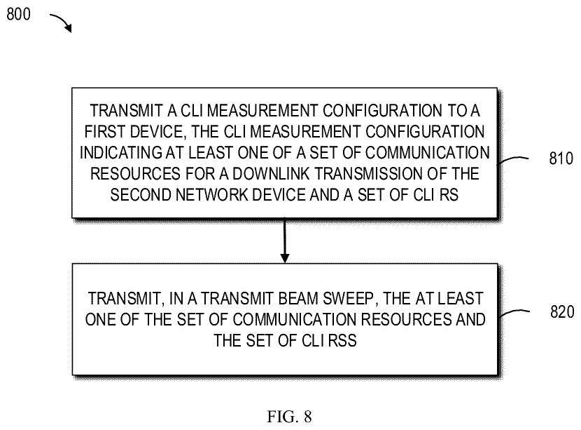

FIG. 8 illustrates a flowchart of a method 800 of communication implemented at a network device in accordance with some embodiments of the present disclosure. The method 800 can be implemented at the second network terminal device 120 shown in FIG. 1. For the purpose of discussion, the method 800 will be described with reference to FIG. 1. It is to be understood that the method 800 may include additional acts not shown and/or may omit some shown acts, and the scope of the present disclosure is not limited in this regard.

At 810, the second network device 120 transmits a CLI measurement configuration to the first device 110. The CLI measurement configuration indicates at least one of a set of communication resources for a downlink transmission of the second network device or a set of CLI RS.

At 820, the second network device 120 transmits, in a transmit beam sweep, the at least one of the set of communication resources or the set of CLI RSs.

In some embodiments, the second network device 120 transmits the CLI measurement configuration via AMF or OAM.

In some embodiments, a CLI RS of the set of CLI RS comprises at least one of CSI RS specific to a serving cell associated with the second network device and SSB.

In some embodiments, the CLI measurement configuration indicating the set of communication resources is indicative at least one of: a set of Orthogonal Frequency Division Multiplexing (OFDM) symbols; a set of Physical Resource Blocks (PRB) of each frequency sub-band; and a set of Transmission Configuration Indication (TCI) states, each corresponding to a transmit beam of the second network device for the each frequency sub-band, each TCI state is indicated by a CLI RS resource ID.

In some embodiments, the second network device 120 transmits the at least one of the set of communication resources and the set of CLI RSs comprising: transmits, across a plurality of discontinuous frequency sub-bands of the second devices, the at least one of the set of communication resources and the set of CLI RSs.

In some embodiments, the method 800 further comprises the second network device 120 receives, from the first network device 110, a CLI measurement report which is generated based on the measurement and wherein the CLI measurement report comprises: a first number of CLI RS resource IDs, a CLI RS resource ID in the first number of CLI RS resource ID corresponds a CLI RS resource having one of the first number of measurement values of the measurement performed on the set of CLI RS, each of the first number measurement values is greater than a first threshold, the measurement value comprising at least one of RSRP, RSSI and SINR, the first number being an integer larger than or equal to one

In some embodiments, the CLI measurement report further comprises: the first number of measurement values each corresponding to a CLI RS resource ID in the first number of CLI RS resource ID.

In some embodiments, the method 800 further comprises the second network devices receives, from the first device 110, a CLI measurement report which is generated based on the measurement and wherein the CLI measurement report comprises: a second number of CLI RS resource ID, a CLI RS resource ID in the second number of CLI RS resource ID corresponds a CLI RS resource having one of the second number of measurement values of the measurement performed on the set of CLI RS, each of the second number of measurement values is smaller than a second threshold, the second number being an integer larger than or equal to one.

In some embodiments, the CLI measurement report further comprises: the second number of measurement values each corresponding to a CLI RS resource ID in the second number of CLI RS resource ID.

In some embodiments, the method 800 further comprises the second network devices receives, from the first device 110, CLI measurement report which is generated based on the measurement and wherein the CLI measurement report comprises: CLI RS resource ID specified to a frequency sub-band, wherein CLI RS resource ID corresponds to a CLI RS having the largest measurement value in the frequency sub-band.

In some embodiments, the second network device 120 receives the CLI measurement report periodically; receives the CLI measurement report based on a timing configuration received from at least one of OAM and AMF, the timing configuration indicating at least one of periodic, slot index and time offset; and receives the CLI measurement report on a predefined slot.

In some embodiments, the method 800 further comprises the second network device 120 performs downlink transmission using a transmit beam determined based on the CLI measurement report, wherein the transmit beam corresponds to at least one of: a first CLI RS ID other than the first number of CLI RS IDs, and a second CLI RS ID in the second number of CLI RS IDs.

In some embodiments, the method 800 further comprises transmitting, to a terminal device served by the second network device 120, a downlink configuration indicating the determined transmit beam.

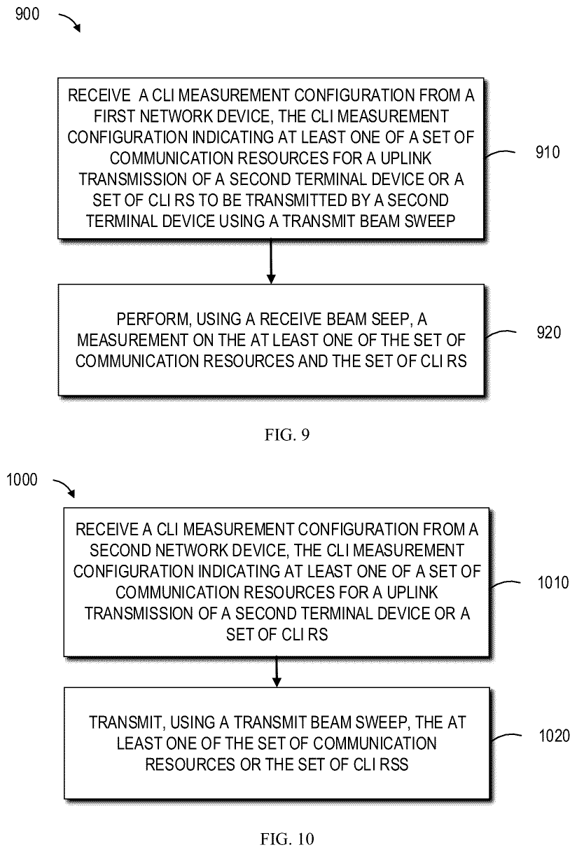

FIG. 9 illustrates a flowchart of a method 900 of communication implemented at a terminal device in accordance with some embodiments of the present disclosure. The method 900 can be implemented at the first terminal device 410 shown in FIG. 4. For the purpose of discussion, the method 900 will be described with reference to FIG. 4. It is to be understood that the method 900 may include additional acts not shown and/or may omit some shown acts, and the scope of the present disclosure is not limited in this regard.

At block 910, the first terminal device 410 receives a CLI measurement configuration from the first network device 430. The CLI measurement configuration indicates at least one of a set of communication resources for a uplink transmission of a second terminal device or a set of CLI Reference Signals (RS) to be transmitted by the second terminal device 420 using a transmit beam sweep.

At block 920, the first terminal device 410 performs, using a receive beam sweep, a measurement on the at least one of the set of communication resources or the set of CLI RSs.

In some embodiments, a CLI RS of the set of CLI RS comprises a Sounding Reference Signal (SRS).

In some embodiments, the first terminal device 410 performs the measurement comprising measuring at least one of Reference Signal Receiving Power (RSRP) and Signal to Interference plus Noise Ratio (SINR) of each RS in the set of CLI RS.

In some embodiments, the CLI measurement configuration indicating the set of communication resources is indicative at least one of: a set of Orthogonal Frequency Division Multiplexing (OFDM) symbols; a set of Physical Resource Blocks (PRB) of each frequency sub-band; a set of Transmission Configuration Indication (TCI) states of which each corresponds to a respective receive beam of the first terminal device, each TCI state is indicated by a CLI RS resource ID.

In some embodiments, the first terminal device 410 performs the measurement comprising measuring at least one of RSSI and the SINR of each communication resource in the set of communication resources.

In some embodiments, the method 900 further comprises the first terminal device 410 transmits, to the first network device 430, a CLI measurement report which is generated based on the measurement, and wherein the CLI measurement report comprises: a first number of TCI state IDs, a TCI state ID in the first number of TCI state IDs corresponds a CLI RS resource having one of the first number of measurement values of the measurement performed on the set of CLI RS, each of the first number of measurement values is larger than a first threshold, the measurement value comprising at least one of RSRP, RSSI and SINR, the first number being an integer larger than or equal to one.

In some embodiments, the CLI measurement report further comprises the first number of measurement values each corresponding to a TCI state ID in the first number of TCI state IDs.

In some embodiments, the method 900 further comprises the first terminal device 410 transmits, to the first network device 430, a CLI measurement report which is generated based on the measurement, and wherein the CLI measurement report comprises: a second number of TCI state IDs, a TCI state ID in the second of TCI state IDs corresponds a CLI RS resource having one of the second number of measurement values of the measurement performed on the set of CLI RS, each of the second number of measurement values is smaller than a second threshold, the second number being an integer larger than or equal to one.

In some embodiments, the CLI measurement report further comprises the second number of measurement values each corresponding to a TCI state ID in the second number of TCI state IDs.

In some embodiments, the method 900 further comprises the first terminal device 410 transmits, to the first network device 430, a CLI measurement report which is generated based on the measurement, and wherein the CLI measurement report comprises: at least one TCI state ID, a TCI state ID of the at least one TCI state ID being associated with a receive beam of the first terminal device.

In some embodiments, the CLI measurement report comprises: timing configuration for transmitting the CLI measurement report.

In some embodiments, the method 900 further comprises in response to the transmitted CLI measurement report, receiving, from the first network device, a downlink configuration indicating a receive beam for downlink reception, and wherein the receive beam corresponds to at least one of: a first TCI state ID other than the first number of TCI state IDs, a second TCI state ID in the second number of TCI state IDs, and the TCI state ID.

In some embodiments, the method 900 further comprises performing a downlink reception using the indicated receive beam.

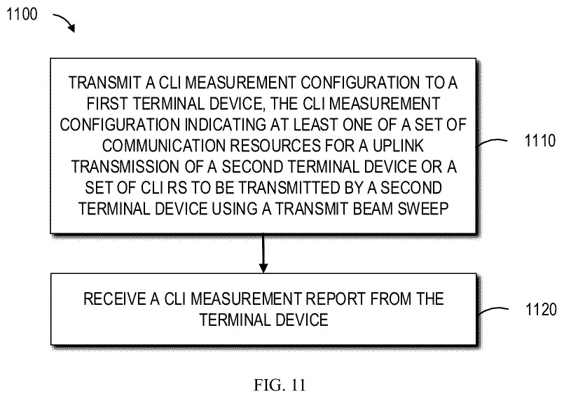

FIG. 10 illustrates a flowchart of a method 1000 of communication implemented at a terminal device in accordance with some embodiments of the present disclosure. The method 1000 can be implemented at the second terminal device 420 shown in FIG. 4. For the purpose of discussion, the method 1000 will be described with reference to FIG. 4. It is to be understood that the method 800 may include additional acts not shown and/or may omit some shown acts, and the scope of the present disclosure is not limited in this regard.

At 1010, the second terminal device 420 receives a Cross Link Interference (CLI) measurement configuration from a second network device. The CLI measurement configuration indicates at least one of a set of communication resources for an uplink transmission of a second terminal device or a set of CLI Reference Signals (RS).

At 1020, the second terminal device 420 transmits, using a transmit beam sweep, the at least one of the set of communication resources or the set of CLI RSs.

In some embodiments, a CLI RS of the set of CLI RS comprises a Sounding Reference Signal (SRS).

In some embodiments, the CLI measurement configuration indicating the set of communication resources is indicative at least one of: a set of Orthogonal Frequency Division Multiplexing (OFDM) symbols; a set of Physical Resource Blocks (PRB) of each frequency sub-band; a set of Transmission Configuration Indication (TCI) states of which each corresponds to a respective receive beam of the first terminal device, each TCI state is indicated by a CLI RS resource ID.

FIG. 11 illustrates a flowchart of a method 1100 of communication implemented at a network device in accordance with some embodiments of the present disclosure. The method 1100 can be implemented at the first network device 430 shown in FIG. 4. For the purpose of discussion, the method 1100 will be described with reference to FIG. 4. It is to be understood that the method 800 may include additional acts not shown and/or may omit some shown acts, and the scope of the present disclosure is not limited in this regard.

At 1110, the first network device 430 transmits a CLI measurement configuration to the first terminal device 410. The CLI measurement configuration indicates at least one of a set of communication resources for a uplink transmission of a second terminal device or a set of CLI Reference Signals (RS) to be transmitted by a second terminal device 420 using a transmit beam sweep.

In some embodiments, the CLI measurement report comprises: a first number of TCI state IDs, a TCI state ID in the first number of TCI state IDs corresponds a CLI RS resource having one of the first number of measurement values of the measurement performed on the set of CLI RS, each of the first number of measurement values is larger than a first threshold, the measurement value comprising at least one of RSRP, RSSI and SINR, the first number being an integer larger than or equal to one.

In some embodiments, the CLI measurement report further comprises the first number of measurement values each corresponding to a TCI state ID in the first number of TCI state IDs.

In some embodiments, the CLI measurement report comprises: a second number of TCI state IDs, a TCI state ID in the second of TCI state IDs corresponds a CLI RS resource having one of the second number of measurement values of the measurement performed on the set of CLI RS, each of the second number of measurement values is smaller than a second threshold, the second number being an integer larger than or equal to one.

In some embodiments, the CLI measurement report further comprises the second number of measurement values each corresponding to a TCI state ID in the second number of TCI state IDs.

In some embodiments, the CLI measurement report comprises at least one TCI state ID, a TCI state ID of the at least one TCI state ID being associated with a receive beam of the first terminal device.

In some embodiments, the CLI measurement report comprises timing configuration for transmitting the CLI measurement report.

In some embodiments, the method 1100 further comprises in response to the received CLI measurement report, the first network device 430 transmits, to the first terminal device 410, a downlink configuration indicating a receive beam of the first terminal device, and wherein the indicated receive beam corresponds to at least one of: a first TCI state ID other than the first number of TCI state IDs, a second TCI state ID in the second number of TCI state IDs, and the TCI state ID.

In some embodiments, the CLI measurement configuration is determined based on uplink information received from a second network device, the uplink information indicating at least uplink resource for a second terminal device

In some embodiments, the CLI measurement configuration is configured by at least one of AMF and OAM.

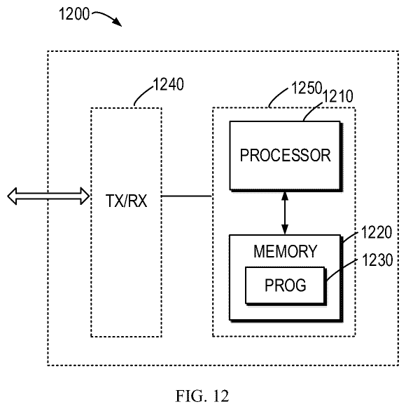

FIG. 12 is a simplified block diagram of a device 1200 that is suitable for implementing some embodiments of the present disclosure. The device 1200 can be considered as a further example embodiment of the network devices 110, 120, 430 and 440 as shown in FIGS. 1 and 4, or terminal devices 410 and 420 as shown in FIG. 4. Accordingly, the device 1200 can be implemented at or as at least a part of the above network devices or terminal devices.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1220 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1230 is assumed to include program instructions that, when executed by the associated processor 1210, enable the device 1200 to operate in accordance with the embodiments of the present disclosure, as discussed herein with reference to FIGS. 2-11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

In some embodiments, a terminal device comprises circuitry configured to perform method 700, 800 and/or 1100.

In some embodiments, a network device comprises circuitry configured to perform method 900 and/or 1000.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, technique terminal devices or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 3 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

In summary, embodiments of the present disclosure may provide the following solutions.

A communication method, comprising: receiving, at a first network device, a Cross Link Interference (CLI) measurement configuration from a second network device, the CLI measurement configuration indicating at least one of: a set of communication resources for a downlink transmission of the second network device or a set of CLI Reference Signals (RS) to be transmitted by the second network device using a transmit beam sweep; and performing, using a receive beam sweep, a measurement on the at least one of the set of communication resources or the set of CLI RSs.

In one embodiment, wherein receiving the CLI measurement configuration comprises at least one of: receiving the CLI measurement configuration via Access and Mobility Management Function (AMF) or Operation Administration and Maintenance (OAM).

In one embodiment, wherein a CLI RS of the set of CLI RS comprises at least one of: Channel State Information (CSI) RS specific to a serving cell associated with the second network device, and Synchronization Signal Block (SSB).

In one embodiment, wherein performing the measurement comprising: measuring at least one of Reference Signal Receiving Power (RSRP) and Signal to Interference plus Noise Ratio (SINR) of each RS in the set of CLI RS.

In one embodiment, wherein the CLI measurement configuration indicating the set of communication resources is indicative at least one of: a set of Orthogonal Frequency Division Multiplexing (OFDM) symbols; a set of Physical Resource Blocks (PRB) of each frequency sub-band; and a set of Transmission Configuration Indication (TCI) states, each corresponding to a transmit beam of the second network device for the each frequency sub-band, each TCI state is indicated by a CLI RS resource ID.

In one embodiment, wherein performing the measurement comprising: measuring at least one of Received Signal Strength Indicator (RSSI) and the SINR of each communication resource in the set of communication resources.

In one embodiment, wherein performing the measurement comprising: performing the measurement across a plurality of discontinuous sub-bands of the second network device.

In one embodiment, the method as above, further comprising transmitting, to the second device, a CLI measurement report which is generated based on the measurement and wherein the CLI measurement report comprises: a first number of CLI RS resource IDs, a CLI RS resource ID in the first number of CLI RS resource ID corresponds a CLI RS resource having one of the first number of measurement values of the measurement performed on the set of CLI RS, each of the first number measurement values is greater than a first threshold, the measurement value comprising at least one of RSRP, RSSI and SINR, the first number being an integer larger than or equal to one.

In one embodiment, wherein the CLI measurement report further comprises: the first number of measurement values each corresponding to a CLI RS resource ID in the first number of CLI RS resource ID.

In one embodiment, the method as above, further comprising transmitting, to the second device, a CLI measurement report which is generated based on the measurement and wherein the CLI measurement report comprises a second number of CLI RS resource ID, a CLI RS resource ID in the second number of CLI RS resource ID corresponds a CLI RS resource having one of the second number of measurement values of the measurement performed on the set of CLI RS, each of the second number of measurement values is smaller than a second threshold, the second number being an integer larger than or equal to one.

In one embodiment, wherein the CLI measurement report further comprises: the second number of measurement values each corresponding to a CLI RS resource ID in the second number of CLI RS resource ID.

In one embodiment, the method as above, further comprising transmitting, to the second device, a CLI measurement report which is generated based on the measurement and wherein the CLI measurement report comprises: CLI RS resource ID specified to a frequency sub-band, wherein CLI RS resource ID corresponds to a CLI RS having the largest measurement value in the frequency sub-band.

In one embodiment, the method as above, wherein transmitting the CLI measurement report comprises at least one of: transmitting the CLI measurement report periodically; transmitting the CLI measurement report based on a timing configuration received from at least one of OAM and AMF, the timing configuration indicating at least one of periodic, slot index and time offset; and transmitting the CLI measurement report on a predefined slot.

In one embodiment, wherein transmitting the CLI measurement report comprises: in response to a measurement value indicating signal quality being greater than a threshold, transmitting the CLI measurement report.

In one embodiment, the method as above, further comprising: determining a receive beam affected by CLI based on a measurement value; and performing an uplink reception using a receive beam of the first network device other than the receive beam affected by CLI from the second device.

A communication method, comprising: transmitting, at a second network device, a Cross Link Interference (CLI) measurement configuration to a first device, the CLI measurement configuration indicating at least one of a set of communication resources for a downlink transmission of the second network device or a set of CLI Reference Signals (RS); and transmitting, in a transmit beam sweep, the at least one of the set of communication resources or the set of CLI RSs.

In one embodiment, wherein transmitting the CLI measurement configuration comprises at least one of: transmitting the CLI measurement configuration via Access and Mobility Management Function (AMF) or Operation Administration and Maintenance (OAM).

In one embodiment, wherein a CLI RS of the set of CLI RS comprises at least one of Channel State Information (CSI) RS specific to a serving cell associated with the second network device and Synchronization Signal Block (SSB).

In one embodiment, wherein the CLI measurement configuration indicating the set of communication resources is indicative at least one of: a set of Orthogonal Frequency Division Multiplexing (OFDM) symbols; a set of Physical Resource Blocks (PRB) of each frequency sub-band; and a set of Transmission Configuration Indication (TCI) states of which each corresponding to a transmit beam of the second network device for the each frequency sub-band, wherein each TCI state is indicated by a CLI RS resource ID.

In one embodiment, wherein transmitting the at least one of the set of communication resources and the set of CLI RSs comprising: transmitting, across a plurality of discontinuous frequency sub-bands of the second devices, the at least one of the set of communication resources and the set of CLI RSs.

In one embodiment, the method as above, further comprising receiving, from the first network device, a CLI measurement report which is generated based on the measurement and wherein the CLI measurement report comprises: a first number of CLI RS resource IDs, a CLI RS resource ID in the first number of CLI RS resource ID corresponds a CLI RS resource having one of the first number of measurement values of the measurement performed on the set of CLI RS, each of the first number measurement values is greater than a first threshold, the measurement value comprising at least one of RSRP, RSSI and SINR, the first number being an integer larger than or equal to one.

In one embodiment, wherein the CLI measurement report further comprises: the first number of measurement values each corresponding to a CLI RS resource ID in the first number of CLI RS resource ID.

In one embodiment, the method as above, further comprising receiving, from the first device, a CLI measurement report which is generated based on the measurement and wherein the CLI measurement report comprises: a second number of CLI RS resource ID, a CLI RS resource ID in the second number of CLI RS resource ID corresponds a CLI RS resource having one of the second number of measurement values of the measurement performed on the set of CLI RS, each of the second number of measurement values is smaller than a second threshold, the second number being an integer larger than or equal to one.

In one embodiment, wherein the CLI measurement report further comprises: the second number of measurement values each corresponding to a CLI RS resource ID in the second number of CLI RS resource ID.

In one embodiment, the method as above, further comprising receiving, from the first device, a CLI measurement report which is generated based on the measurement and wherein the CLI measurement report comprises: CLI RS resource ID specified to a frequency sub-band, wherein CLI RS resource ID corresponds to a CLI RS having the largest measurement value in the frequency sub-band.

In one embodiment, wherein receiving the CLI measurement report comprising at least one of: receiving the CLI measurement report periodically; receiving the CLI measurement report based on a timing configuration received from at least one of OAM and AMF, the timing configuration indicating at least one of periodic, slot index and time offset; and receiving the CLI measurement report on a predefined slot.

In one embodiment, the method as above, further comprising: performing downlink transmission using a transmit beam determined based on the CLI measurement report, wherein the transmit beam corresponds to at least one of: a first CLI RS ID other than the first number of CLI RS IDs, and a second CLI RS ID in the second number of CLI RS IDs.

In one embodiment, the method as above, further comprising: transmitting, to a terminal device served by the second network device, a downlink configuration indicating the determined transmit beam.

A communication method, comprising: receiving, at a first terminal device, a Cross Link Interference (CLI) measurement configuration from a first network device, the CLI measurement configuration indicating at least one of a set of communication resources for a uplink transmission of a second terminal device or a set of CLI Reference Signals (RS) to be transmitted by a second terminal device using a transmit beam sweep; and performing, using a receive beam sweep, a measurement on the at least one of the set of communication resources or the set of CLI RSs.

In one embodiment, wherein a CLI RS of the set of CLI RS comprises a Sounding Reference Signal (SRS).

In one embodiment, the method as above, wherein performing the measurement comprising: measuring at least one of Reference Signal Receiving Power (RSRP) and Signal to Interference plus Noise Ratio (SINR) of each RS in the set of CLI RS.

In one embodiment, wherein the CLI measurement configuration indicating the set of communication resources is indicative at least one of: a set of Orthogonal Frequency Division Multiplexing (OFDM) symbols; a set of Physical Resource Blocks (PRB) of each frequency sub-band; and a set of Transmission Configuration Indication (TCI) states of which each corresponds to a respective receive beam of the first terminal device, each TCI state being indicated by a CLI RS resource ID.

In one embodiment, wherein performing the measurement comprising: measuring at least one of Received Signal Strength Indicator (RSSI) and the SINR of each communication resource in the set of communication resources.

In one embodiment, the method as above, further comprising transmitting, to the first network device, a CLI measurement report which is generated based on the measurement, and wherein the CLI measurement report comprises: a first number of TCI state IDs, a TCI state ID in the first number of TCI state IDs corresponds a CLI RS resource having one of the first number of measurement values of the measurement performed on the set of CLI RS, each of the first number of measurement values is larger than a first threshold, the measurement value comprising at least one of RSRP, RSSI and SINR, the first number being an integer larger than or equal to one.

In one embodiment, the method as above, wherein the CLI measurement report further comprises: the first number of measurement values each corresponding to a TCI state ID in the first number of TCI state IDs.

In one embodiment, the method as above, further comprising transmitting, to the first network device, a CLI measurement report which is generated based on the measurement, and wherein the CLI measurement report comprises: a second number of TCI state IDs, a TCI state ID in the second of TCI state IDs corresponds a CLI RS resource having one of the second number of measurement values of the measurement performed on the set of CLI RS, each of the second number of measurement values is smaller than a second threshold, the second number being an integer larger than or equal to one.

In one embodiment, wherein the CLI measurement report further comprises: the second number of measurement values each corresponding to a TCI state ID in the second number of TCI state IDs.

In one embodiment, the method as above, further comprising transmitting, to the first network device, a CLI measurement report which is generated based on the measurement, and wherein the CLI measurement report comprises: at least one TCI state ID, a TCI state ID of the at least one TCI state ID being associated with a receive beam of the first terminal device.

In one embodiment, the method as above, wherein the measurement report further comprises: timing configuration for transmitting the CLI measurement report.

In one embodiment, the method as above, further comprising: in response to the transmitted CLI measurement report, receiving, from the first network device, a downlink configuration indicating a receive beam for downlink reception, and wherein the receive beam corresponds to at least one of: a first TCI state ID other than the first number of TCI state IDs, a second TCI state ID in the second number of TCI state IDs, and the TCI state ID.

In one embodiment, the method as above, further comprising: performing a downlink reception using the indicated receive beam.

In one embodiment, wherein the CLI measurement report is transmitted periodically, and wherein the CLI measurement report is transmitted in Physical Uplink Control Channel (PUCCH), the PUCCH being transmitted on a transmit beam which is same as the transmit beam for at least one of a latest Physical Uplink Shared Channel (PUSCH) and a latest Physical Radom Access Channel (PRACH).

In one embodiment, the method as above, wherein the CLI measurement report is transmitted in response to receiving Downlink Control Information requesting the CLI measurement report.

In one embodiment, the method as above, wherein the CLI measurement report is transmitted in a communication resource which is configured by the first network device, the communication resource being configured based on a communication resource for SSB transmission.

45. A communication method, comprising: receiving, at a second terminal device, a Cross Link Interference (CLI) measurement configuration from a second network device, the CLI measurement configuration indicating at least one of a set of communication resources for a uplink transmission of a second terminal device or a set of CLI Reference Signals (RS); and transmitting, using a transmit beam sweep, the at least one of the set of communication resources or the set of CLI RSs.

In one embodiment, wherein a CLI RS of the set of CLI RS comprises a Sounding Reference Signal (SRS).

In one embodiment, wherein the CLI measurement configuration indicating the set of communication resources is indicative at least one of: a set of Orthogonal Frequency Division Multiplexing (OFDM) symbols; a set of Physical Resource Blocks (PRB) of each frequency sub-band of the second terminal device; a set of Transmission Configuration Indication (TCI) states, each TCI state corresponds to a respective receive beam of the first terminal device, wherein each TCI state is indicated by a CLI RS resource ID.

A communication method, comprising: transmitting, at a first network device, a Cross Link Interference (CLI) measurement configuration to a first terminal device, the CLI measurement configuration indicating at least one of a set of communication resources for a uplink transmission of a second terminal device or a set of CLI Reference Signals (RS) to be transmitted by a second terminal device using a transmit beam sweep; and receiving a CLI measurement report from the terminal device.

In one embodiment, wherein the CLI measurement report comprises: a first number of TCI state IDs, a TCI state ID in the first number of TCI state IDs corresponds a CLI RS resource having one of the first number of measurement values of a measurement performed by the first terminal device on the set of CLI RS, each of the first number measurement values is larger than a first threshold, the measurement value comprising at least one of RSRP, RSSI and SINR, the first number being an integer larger than or equal to one.

In one embodiment, wherein the CLI measurement report further comprises: the first number of measurement values each corresponding to a TCI state ID in the first number of TCI state IDs.

In one embodiment, the CLI measurement report comprises: a second number of TCI state IDs, a TCI state ID in the second of TCI state IDs corresponds a CLI RS resource having one of the second number of measurement values of the measurement performed by the first terminal device on the set of CLI RS, each of the second number of measurement values is smaller than a second threshold, the second number being an integer larger than or equal to one.

In one embodiment, wherein the CLI measurement report further comprises: the second number of measurement values each corresponding to a TCI state ID in the second number of TCI state IDs.

In one embodiment, the method as above, wherein the CLI measurement report comprises: at least one TCI state ID, a TCI state ID of the at least one TCI state ID being associated with a receive beam of the first terminal device.

In one embodiment, wherein the CLI measurement report comprises: timing configuration for transmitting the CLI measurement report.

In one embodiment, the method as above, further comprising: in response to the received CLI measurement report, transmitting, to the first terminal device, a downlink configuration indicating a receive beam of the first terminal device, and wherein the indicated receive beam corresponds to at least one of: a first TCI state ID other than the first number of TCI state IDs, a second TCI state ID in the second number of TCI state IDs, and the TCI state ID.

In one embodiment, wherein the CLI measurement configuration is determined based on uplink information received from a second network device, the uplink information indicating at least uplink resource for a second terminal device.

In one embodiment, wherein the CLI measurement configuration is configured by at least one of AMF and OAM.

A network device comprising: a processor; and a memory coupled to the processor and storing instructions thereon, the instructions, when executed by the processor, causing the network device to perform the method according to above methods of communication.

A terminal device comprising: a processor; and a memory coupled to the processor and storing instructions thereon, the instructions, when executed by the processor, causing the terminal device to perform the method according to above methods of communication.

A computer readable medium having instructions stored thereon, the instructions, when executed on at least one processor, causing the at least one processor to perform the method according to above methods of communication.

1. A communication method, comprising:
receiving, at a first network device, a Cross Link Interference (CLI) measurement configuration from a second network device, the CLI measurement configuration indicating at least one of: a set of communication resources for a downlink transmission of the second network device or a set of CLI Reference Signals (RS) to be transmitted by the second network device using a transmit beam sweep;
performing, using a receive beam sweep, a measurement on the at least one of the set of communication resources or the set of CLI RSs.

2. The method of claim 1, wherein a CLI RS of the set of CLI RS comprises at least one of:
Channel State Information (CSI) RS specific to a serving cell associated with the second network device, and
Synchronization Signal Block (SSB).

3. The method of claim 1, wherein the CLI measurement configuration indicating the set of communication resources is indicative at least one of:
a set of Orthogonal Frequency Division Multiplexing (OFDM) symbols;
a set of Physical Resource Blocks (PRB) of each frequency sub-band; and
a set of Transmission Configuration Indication (TCI) states, each TCI state corresponding to a transmit beam of the second network device for the each frequency sub-band, each TCI state being indicated by a CLI RS resource ID.

4. The method of claim 2, wherein performing the measurement comprising:
measuring at least one of Reference Signal Receiving Power (RSRP) and Signal to Interference plus Noise Ratio (SINR) of each RS in the set of CLI RS, or
measuring at least one of Received Signal Strength Indicator (RSSI) and the SINR of each RS in the set of communication resources.

5. The method of claim 1, wherein performing the measurement comprising:
performing the measurement across a plurality of discontinuous sub-bands of the second network device.

6. The method of claim 1, further comprising transmitting, to the second device, a CLI measurement report which is generated based on the measurement and wherein the CLI measurement report comprises:
a first number of CLI RS resource IDs, a CLI RS resource ID in the first number of CLI RS resource ID corresponds a CLI RS resource having one of the first number of measurement values of the measurement performed on the set of CLI RS, each of the first number measurement values is greater than a first threshold, the measurement value comprising at least one of RSRP, RSSI and SINR, the first number being an integer larger than or equal to one.

7. The method of claim 6, wherein the CLI measurement report further comprises:
the first number of measurement values each corresponding to a CLI RS resource ID in the first number of CLI RS resource ID.

8. The method of claim 1, further comprising transmitting, to the second device, a CLI measurement report which is generated based on the measurement and wherein the CLI measurement report comprises:
a CLI RS resource ID specified to a frequency sub-band, wherein the CLI RS resource ID corresponds to a CLI RS having the largest measurement value in the frequency sub-band.

9. A communication method, comprising:
receiving, at a first terminal device, a Cross Link Interference (CLI) measurement configuration from a first network device, the CLI measurement configuration indicating at least one of a set of communication resources for a uplink transmission of a second terminal device or a set of CLI Reference Signals (RS) to be transmitted by the second terminal device using a transmit beam sweep; and
performing, using a receive beam sweep, a measurement on the at least one of the set of communication resources or the set of CLI RSs.

10. The method of claim 9, wherein a CLI RS of the set of CLI RS comprises a Sounding Reference Signal (SRS).

11. The method of claim 9, wherein performing the measurement comprising:
measuring at least one of Reference Signal Receiving Power (RSRP) and Signal to Interference plus Noise Ratio (SINR) of each RS in the set of CLI RS; or
measuring at least one of Received Signal Strength Indicator (RSSI) and the SINR of each RS in the set of communication resources.

12. The method of claim 9, wherein the CLI measurement configuration indicating the set of communication resources is indicative at least one of:
a set of Orthogonal Frequency Division Multiplexing (OFDM) symbols;
a set of Physical Resource Blocks (PRB) of each frequency sub-band;
a set of Transmission Configuration Indication (TCI) states, each TCI state corresponds to a respective receive beam of the first terminal device, each TCI state being indicated by a CLI RS resource ID.

13. The method of claim 9, further comprising transmitting, to the first network device, a CLI measurement report which is generated based on the measurement, and wherein the CLI measurement report comprises:
a first number of TCI state IDs, a TCI state ID in the first number of TCI state IDs corresponds a CLI RS resource having one of the first number of measurement values of the measurement performed on the set of CLI RS, each of the first number of measurement values is larger than a first threshold, the measurement value comprising at least one of RSRP, RSSI and SINR, the first number being an integer larger than or equal to one.

14. The method of claim 13, wherein the CLI measurement report further comprises:
the first number of measurement values each corresponding to a TCI state ID in the first number of TCI state IDs.

15. The method of claim 9, further comprising transmitting, to the first network device, a CLI measurement report which is generated based on the measurement, and wherein the CLI measurement report comprises:
a second number of TCI state IDs, a TCI state ID in the second of TCI state IDs corresponds a CLI RS resource having one of the second number of measurement values of the measurement performed on the set of CLI RS, each of the second number of measurement values is smaller than a second threshold, the second number being an integer larger than or equal to one.

16. The method of claim 15, wherein the CLI measurement report further comprises:
the second number of measurement values each corresponding to a TCI state ID in the second number of TCI state IDs.

17. The method of claim 9, further comprising transmitting, to the first network device, a CLI measurement report which is generated based on the measurement, and wherein the CLI measurement report comprises:
at least one TCI state ID, a TCI state ID of the at least one TCI state ID being associated with a receive beam of the first terminal device.

18. The method of claim 13, further comprising:
in response to the transmitted CLI measurement report, receiving, from the first network device, a downlink configuration indicating a receive beam for downlink reception, and wherein the receive beam corresponds to at least one of:
a first TCI state ID other than the first number of TCI state IDs,
a second TCI state ID in the second number of TCI state IDs.

19. The method of claim 9, wherein the CLI measurement report is transmitted periodically, and wherein the CLI measurement report is transmitted in Physical Uplink Control Channel (PUCCH), the PUCCH being transmitted on a transmit beam which is same as the transmit beam for at least one of a latest Physical Uplink Shared Channel (PUSCH) and a latest Physical Radom Access Channel (PRACH).

20. The method of claim 13, wherein the CLI measurement report is transmitted in response to receiving Downlink Control Information requesting the CLI measurement report.
